(19) United States
(12) Patent Application Publication
(10) Pub. No.: US 2011/0106776 A1
(43) Pub. Date: May 5, 2011

(54) INCREMENTAL IMPLEMENTATION OF UNDO/REDO SUPPORT IN LEGACY APPLICATIONS

(75) Inventor: Torbjorn Vik, Oslo (NO)

(73) Assignee: SCHLUMBERGER TECHNOLOGY CORPORATION, Sugar Land, TX (US)

(21) Appl. No.: 12/611,215

(22) Filed: Nov. 3, 2009

(51) Int. Cl. G06F 17/30

(52) U.S. Cl. 707/698; 707/E17.052; 707/E17.036

(57) ABSTRACT

Systems and methods are described for incremental implementation of undo\redo support in legacy applications. In one implementation, a system enables a per-object undo/redo process to be realized in pre-existing computer programs that have limited or no undo/redo functionality, while minimizing changes to such pre-existing computer programs. An innovative process stores an undo/redo instruction for each user-initiated operation in a data structure, classifies each undo/redo instruction under one or more objects affected by the operation, or vice/versa, and verifies the validity of each undo/redo instruction before performing an undo/redo. In one implementation, the process stores only undo/redo instructions in the data structure for those operations that can be validated beforehand as being undoable/redoable. Various data structure schemes are available, each of which may increase performance while implementing the undo-redo support for a given legacy software, e.g., by increasing speed and/or decreasing data size, memory consumption, disk consumption, power consumption, and so forth. The ability to validate undoability/redoability before performing an undo/redo operation gives the architecture versatility for updating many different applications.

### RELATED APPLICATIONS

This patent application is related to U.S. patent application Ser. No. ______ to Vik, Attorney Docket No. 94.0228, entitled, “Undo/Redo Operations For Multi-Object Data,” filed concurrently herewith, and incorporated herein by reference in its entirety.

### BACKGROUND

Conventional undo/redo techniques can be linear or nonlinear. The linear techniques undo/redo operations in a strict reverse of the order in which they occurred, while the nonlinear techniques allow the operation to be undone/redone out-of-order from the order of a chronological stack. The latter poses serious obstacles as the data to be reversed may not be in the correct state for an out-of-order reversion to an earlier state.

In conventional off-the-shelf software applications, the number of previous actions that can be undone/redone varies by program. For example, the stack size may range from twenty or thirty stored operations in graphics programs to two or three previous edits in simple programs. Elementary undo/redo capability may accomplish “redo” by processing undo/redo operations as actions that can, in turn, be undone/redone.

Many legacy computer programs and software applications possess unsatisfactory undo/redo capabilities. Some applications have no undo/redo capability. Many require strict reversal of a chronological stack of recorded operations, so that the user must often undo/redo valuable edits in order to get back to the particular operation that the user wants undone/redone.

U.S. Pat. No. 5,481,710 to Keane et al. discloses a method and system for providing application programs with an undo/redo function. However, the Keane system only undoes the most recent action from an overall stack of actions, and requires significant modification of the program being updated.

U.S. Pat. No. 7,003,695 to Li discloses an undo/redo algorithm for a computer program, but is somewhat limited to display-screen objects and to a modification log for the display-screen objects that is minimized to changes in object attributes and z-order display parameters.

Additional history and theory of undo/redo schemes are available in “A Formal Approach To Undo Operations In Programming Languages,” ACM Transactions on Programming Languages and Systems, Vol. 8, No. 1, January 1986, pages 50-87.

### SUMMARY

Systems and methods are described for incremental implementation of undo\redo support in legacy applications. In one implementation, a system enables a per-object undo/redo process to be realized in pre-existing computer programs that have limited or no undo/redo functionality, while minimizing changes to such pre-existing computer programs. An innovative process stores an undo/redo instruction for each user-initiated operation in a data structure, classifies each undo/redo instruction in association with one or more objects affected by the operation, and verifies the validity of each undo/redo instruction before performing an undo/redo. In one implementation, the process only stores undo/redo instructions for those operations that can be validated beforehand as being undoable/redoable.

Various data structure schemes are available, each of which may increase performance while implementing the undo-redo support for a given legacy software, e.g., by increasing speed and/or decreasing data size, memory consumption, disk consumption, power consumption, and so forth.

In one implementation, each undo/redo instruction stored in a data structure may consist of a difference in the state of an object before and after the operation. For example, the undo/redo instruction may consist of metadata indicating an object property that has changed. The undo/redo instruction may alternatively consist of a former version of the object itself, stored remotely from the data structure. The ability to generate an undo/redo instruction for many different modifications to an object and the ability to validate undoability/redoability before performing an undo/redo operation gives the architecture versatility for updating many different applications.

This summary section is not intended to give a full description of incremental implementation of undo/redo support in legacy applications, or to provide a comprehensive list of features and elements. A detailed description with example implementations follows.

### BRIEF DESCRIPTION OF THE DRAWINGS

FIG. 1 is a diagram of an example environment for practicing an innovative undo-redo support architecture.

FIG. 2 is a block diagram of an innovative undo/redo support module.

FIG. 3 is a class diagram showing innovative validity properties associated with innovative undo/redo actions.

FIG. 4 is a diagram of an example data structure from which per-object undo/redo instructions may be derived.

FIG. 5 is a diagram of an example data structure for storing per-object undo/redo instructions.

FIG. 6 is a diagram of example differential nodes and state-based nodes on branches of a hierarchical tree in the data structure of FIG. 5.

FIG. 7 is a diagram of an example undo/redo menu generated from information stored in nodes of the data structures of FIG. 4 and FIG. 5.

FIG. 8 is a flow diagram of an example method of building a data structure to implement undo/redo support in legacy applications.

FIG. 9 is flow diagram of an example method of generating nodes to represent undo/redo operations.

FIG. 10 is a flow diagram of an example method of verifying the undoability/redoability of an operation before applying an undo/redo instruction.

### DETAILED DESCRIPTION

### Overview

This disclosure describes innovative systems and methods for incremental implementation of undo\redo support in legacy applications. In one implementation, a system enables a per-object undo/redo process to be realized in a pre-existing computer program that has limited or no undo/redo functionality, while minimizing changes to the pre-existing computer program.

In many implementations, the systems and methods described herein can add undo/redo functionality to an existing computer program without requiring much, if any, modification to the program. The amount of modification needed depends on the program, and what undo/redo capabilities the program already has. Many software applications adhere to interface protocols and possess programming interfaces that enable transfer of information to an innovative undo/redo support module that may be integrated into the legacy code or made accessible as an external program in communication with a running version that is based on the legacy code.

Many software applications are written in an object-oriented manner that can greatly reduce complexity of interfacing with the innovative architecture. Further, many software applications are written in programming languages that inherently track object properties, so that neither the pre-existing software application nor the innovative system and architecture have to be modified to add the improved undo/redo support. Thus, in many instances, the innovative system provides a generic or universal upgrade or add-on, which provides per-object undo/redo capabilities to software applications that are deficient in undo/redo functionality.

The undo/redo actions made possible in a pre-existing software application through the innovative techniques described herein improve upon conventional undo/redo and redo techniques that are constrained to the rigid sequence of a single chronological history of operations performed globally across an entire data set. In conventional undo/redo scenarios, the user must accept an undo sequence that backtracks edits in a reverse order of the literal chronological order in which the original edits occurred anywhere in the data set. Likewise, conventional redo operations re-execute operations in the same unchangeable sequence of operations that were undone. Thus, conventional undo/redo techniques require the user to accept unwanted operations while accomplishing the desirable ones.

In the architecture described herein, an innovative process verifies the validity of each undo/redo instruction before performing the undo/redo. This is an important feature that adds robustness and versatility to the innovative architecture, as the step of validating the undoability/redoability of each operation before performing the undo/redo makes the innovative architecture compatible with many programs.

In one implementation, the innovative undo/redo operations can be applied to separate objects, or even parts of objects, within a data set, without having to undo/redo within a rigid chronological sequence of recorded operations. As used herein, the term “object” means an object or a part of an object. That is, a user or an innovative process may select or partition an object into parts or features, in which case each part or feature can be treated as an object in its own right, with its own associated operations to be undone/redone.

Thus, “object” as used herein means a logical subset or a selected subset of data within a larger data set, designated as a nexus for undo/redo operations associated with that subset. “Features” and “objects” will be referred to herein as “objects.” In one implementation, an object is a visual feature or a logical partition of an application's data set by which a global history of edits can be filtered to provide “per-object” or “across-selected-multiple-objects” undo/redo operations, without having to undo/redo previous edits in strict backward and forward chronological order. A user may also apply undo/redo operations in parallel across multiple objects, rather than following a single linear path of undo/redo operations for one object.

Example Environment

Incremental implementation of undo/redo support in a legacy application generally takes place in the environment of computing hardware. In some instances, the undo/redo support may be implemented almost entirely in hardware, for example, by updating an application specific integrated circuit (ASIC) or by reprogramming a programmable logic controller (PLC). However, the typical environment in which a user wants improved undo/redo capability involves interactive software programs running on a computing device or computer-guided machine that enables the user to create a document, graphic, media presentation, etc., using a software package.

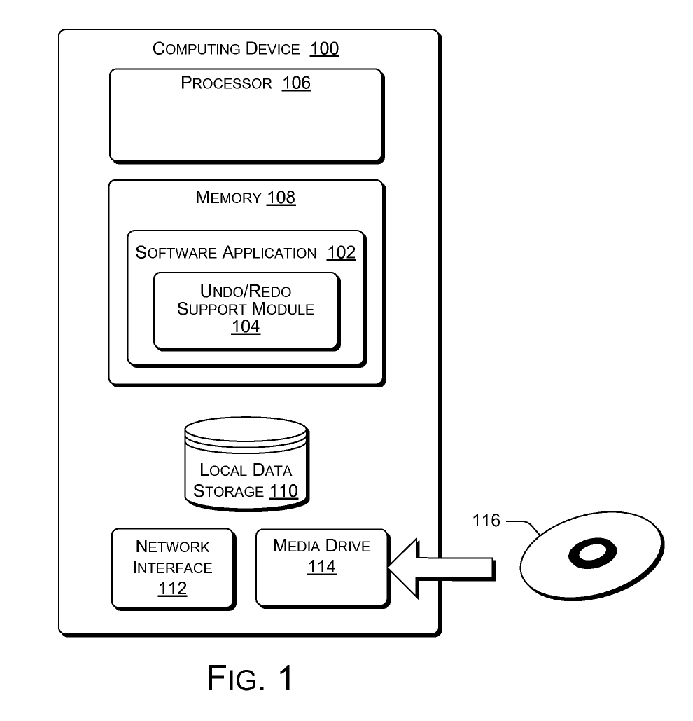

FIG. 1 shows an example computing environment for practicing a system and architecture that supports incremental implementation of undo/redo support in pre-existing computer programs. A computing device 100 runs the pre-existing computer program, i.e., a software application 102, by executing instructions that constitute the program's code. The software application 102 typically generates an application data set and operates on objects represented within the application data set. To achieve the improved undo/redo support, the software application 102 includes or has access to an innovative undo/redo support module 104 either integrated into its programming code through an upgrade or accessible through a program interface.

The computing device 100, hosting both the software application 102 and the undo/redo support module 104, also includes typical hardware components, such as a processor 106, memory 108, local data storage 110, a network interface 112, and a media drive 114, such as an optical disk read/write device for receiving a removable storage medium 116. The removable storage medium 116 can be, for example, a compact disk (CD) or digital versatile disk/digital video disk (DVD) that may include instructions for implementing and executing the undo/redo support module 104. In a manner similar to the software application 102, which can exist at least in part as software instructions in the memory 108, at least some parts of the innovative undo/redo support module 104 can be stored as instructions on a given instance of the removable storage medium 116 or removable device or in local data storage 110, to be loaded into memory 108 for execution by the processor 106.

The undo/redo actions made possible in the software application 102 through the innovative techniques described herein improve upon conventional undo/redo techniques that are often constrained to the rigid sequence of a single chronological history of operations performed globally across an entire data set. In the architecture described herein, an innovative process stores an undo/redo instruction for each user-initiated operation of the computer program in a data structure, associates each undo/redo instruction with one or more objects affected by the operation, and importantly, verifies the validity of each undo/redo instruction before performing an undo/redo. This is an important feature that adds robustness and versatility to the innovative architecture, as the step of validating the undoability/redoability of each operation before performing the undo/redo makes the innovative architecture compatible with many programs.

Example Engine

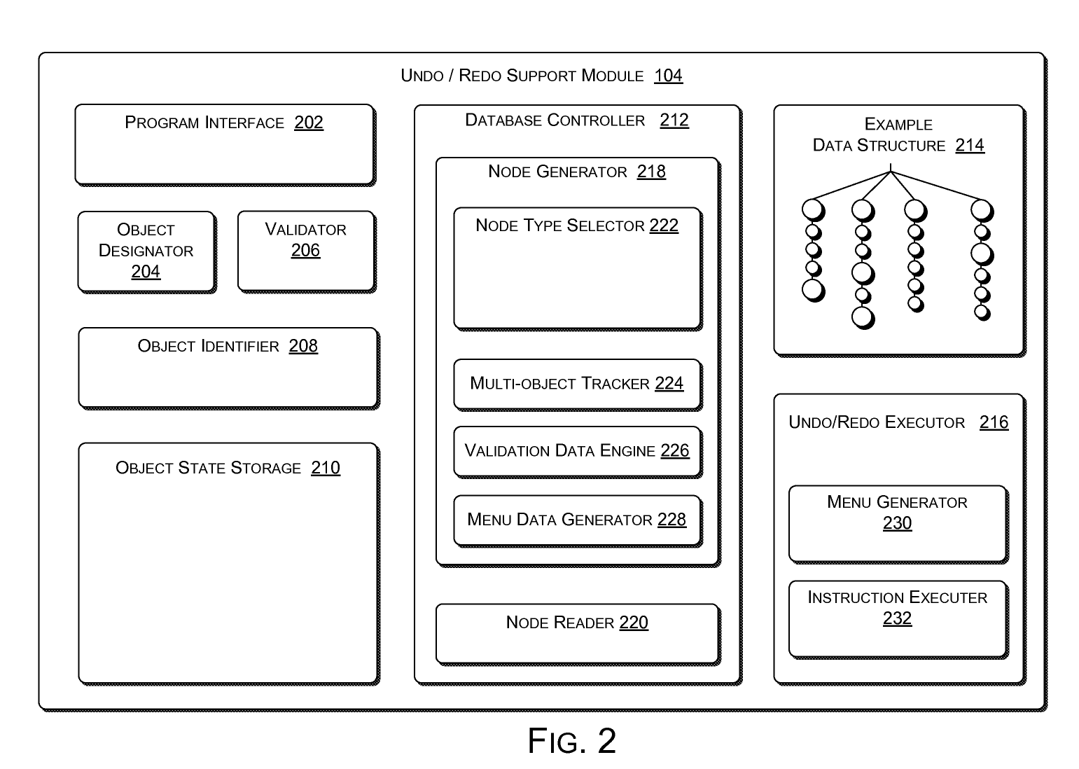

FIG. 2 shows an example undo/redo support module 104. The illustrated implementation is only one example configuration, to introduce features and components of an engine that performs innovative undo/redo support for pre-existing applications. Many other arrangements of the components of an innovative undo-redo support module 104 are possible within the scope of the subject matter. As introduced above, the undo-redo support module 104 can be implemented in hardware, or in combinations of hardware and software. Illustrated components are communicatively coupled with each other as needed.

A list of example components for one implementation of the undo-redo support module 104 includes a program interface 202 for communicating with the pre-existing software application 102 being supported with new or additional undo/redo services, an object designator 204, a validator 206, an object identifier 208, object state storage 210, a database controller 212 that administers an example data structure 214, and an undo/redo executor 216.

The database controller 212 may further include a node generator 218 and a node reader 220. The node generator 218, in turn, includes a node type selector 222 that in one implementation, may further include a differential size evaluator and an object size evaluator. The node generator 218 may also include a multi-object tracker 224, a validation data engine 226, and a menu data generator 228. The undo/redo executor 216 may further include an optional menu generator 230 and an undo/redo instruction executor 232.

The example data structure 214, in one sense, forms a central part of the undo/redo support module 104. The example data structure 214 is a database that associates each user-initiated operation performed by software application 102 with the object or objects modified by the operation. The example data structure 214, in one implementation, also relates each operation to an undo/redo instruction for reversing or “undoing” the operation. In one implementation, for example, the example data structure 214 is a database of undo instructions or undo nodes, each of which may also be reversed, providing redo instructions.

In one implementation, in order to provide generic undo/redo support for a number of different software applications 102, the undo/redo support module 104 has built-in verification of undoability/redoability for each candidate undo-redo operation. The validator 206 checks whether a former state of the individual object (or corresponding part of the application data set) can be reverted back to. In some instances, an undo/redo action cannot restore the application data set to a former state. This may occur because of the complexity of a data transformation achieved by an editing operation, or when provision for an undo/redo algorithm has been purposely omitted because of cost or complexity. In other words, some editing operations are irreversible, either because of their inherent complexity, or because a programming choice has deemed reversibility of the operation not worth the cost.

In undo/redo architecture, each specific interactive user action typically has its own implementation of an algorithm to undo/redo that specific action. Changing a text string, can simply mean taking a copy of the string before the change and restoring the copy if the action is undone/redone. If the amount of data involved is too large to make complete copies, another algorithm may be used to store only the difference caused by the action. But such a differential-based undo/redo algorithm may introduce challenges in terms of correct data outcome.

In the following example, a software application modifies a text string by applying two different interactive actions:

1. Adding the substring “suffix” to a string. This action has undo/redo support implemented through a differential-based algorithm. When undone, it simply removes the last six characters of the string.

2. Reversing the text string. This action does not have undo/redo support.

Assume that the initial string is “text”. Applying action 1 above, results in the string “textsuffix”. Following with action 2 above, gives the string “xiffustxet”. As only action 1 supports undo/redo, only the first action applied is pushed onto the undo/redo stack. Undoing/redoing this action after action 2 has been applied will result in invalid data (“xiff”). In this example, the error is easily spotted by the user. But in a large modeling application, for instance, with a large number of interactive workflows, such errors are difficult to detect and the consequences can be catastrophic to the data.

In one implementation, the undo/redo support module 104 applies the innovative feature of requiring each undo/redo algorithm to verify that the application data set is in the correct state before undoing/redoing or redoing. The undo/redo support module 104 is able to detect, in the example above, whether the object is in the state “textsuffix” so that the operation can be correctly undone/redone. If the validator 206 detects that the data set has been changed to a non-undoable or non-redoable state, it invalidates the action and removes the associated operation from the action history, i.e., from the example data structure 214 and also removes the corresponding undo/redo operations from undo/redo menus.

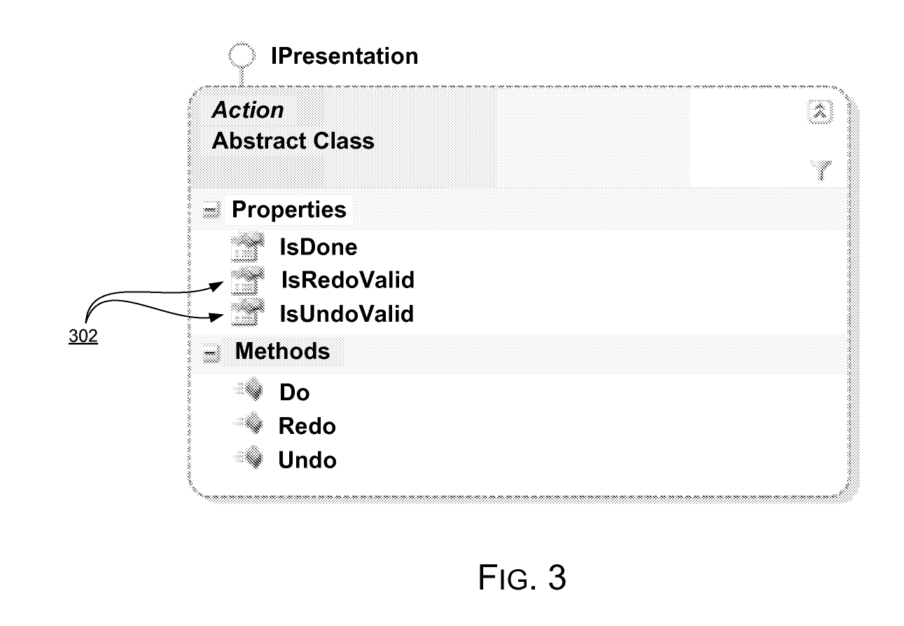

FIG. 3 shows properties and methods for a class of undo/redo actions. Innovative validation properties 302 aim to provide granular verification of undoability/redoability (or redoability) for each undo/redo action. Thus, when the undo/redo support module 104 is used with pre-existing software applications 102, the built-in verification of undoability/redoability aims to provide an independent and generic verification of undo/redo instructions so that the undo/redo support module 104 can be used with many types of pre-existing software applications 102. The validator 206 may apply a knowledge-base of known operations and their known interaction with a software application's data set to decide whether a given operation can be reversed—before the operation and its associated undo/redo instruction are even committed to the example data structure 214.

In another implementation, schemes for checking the state of the object being operated on are saved in the example data structure 214 with the associated undo/redo instruction for that operation. In such a case, the validator 206 is closely associated with the undo/redo executor 216 during runtime to check for undoability/redoability—as undo/redo actions are selected by a user in real time. If the application data set has changed in such a manner that the operation cannot be undone/redone, then the undo/redo instructions for that operation are discarded and the undo/redo action is invalidated.

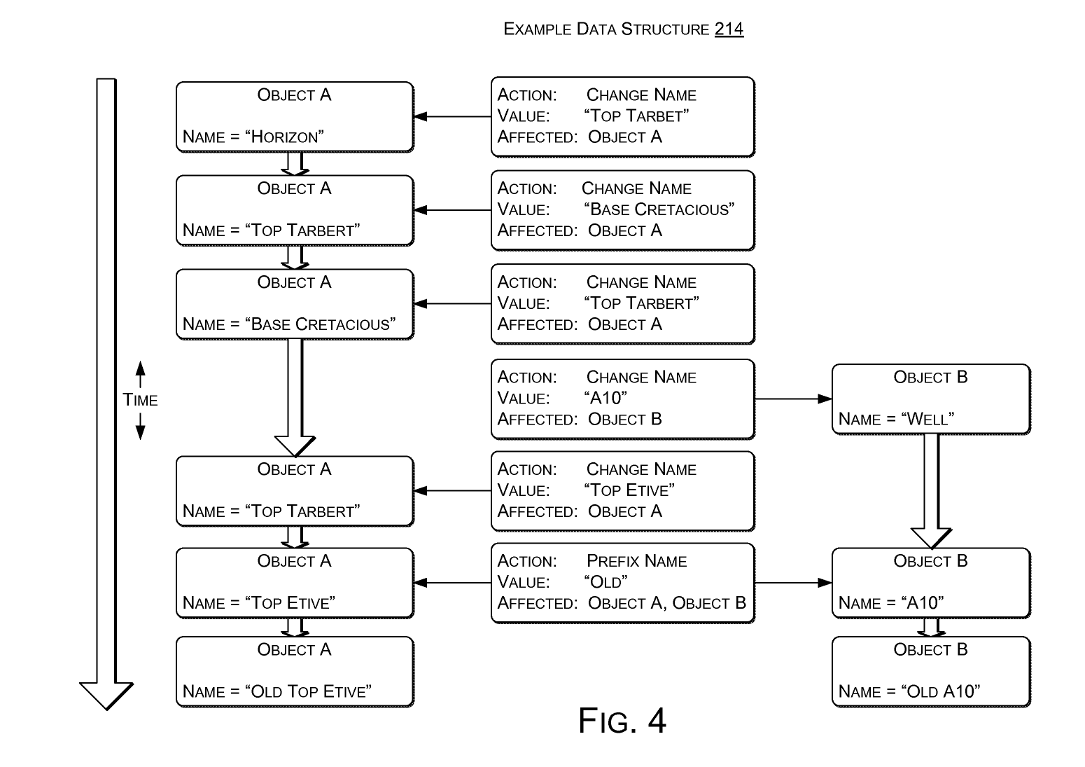

FIG. 4 shows one example of the example data structure 214 of FIG. 2, in greater detail. Use of a given data structure 214 is based on optimizing performance, such as increasing speed and/or decreasing data size, memory consumption, disk consumption, power consumption, and so forth. The example data structure 214 can take numerous forms. FIG. 4 illustrates a data structure 214 for managing user-initiated operations that have occurred in a geophysical modeling application. The illustrated example data structure 214 thus shows part of the editing lifetimes of two objects (A and B) in a given data set. A number of actions are applied to them (center stack) and the example data structure 214 keeps track of which objects were modified. Undo/redo instructions are inherent in the actions recorded, so that operations can be undone by backtracking the chronological stack of recorded operations, and undoing each operation in relation to one or more objects affected by the operation. Likewise, redo operations can sometimes be performed by reversing the backtracking and re-performing the undone operation.

In the illustrated implementation, the undo/redo executor 216 can apply an object filter to find all actions in the example data structure 214 that were applied, for example, to Object A. In one implementation, this filtering produces a second chronological stack of operations belonging to Object A, used as a per-object undo/redo stack, assuming that each consecutive undo/redo action is verifiable as undoable or redoable as needed. In the illustrated example data structure 214, the undo/redo executor 216 can now move backward in the history of Object A without having to undo/redo the single action that was applied only to Object B.

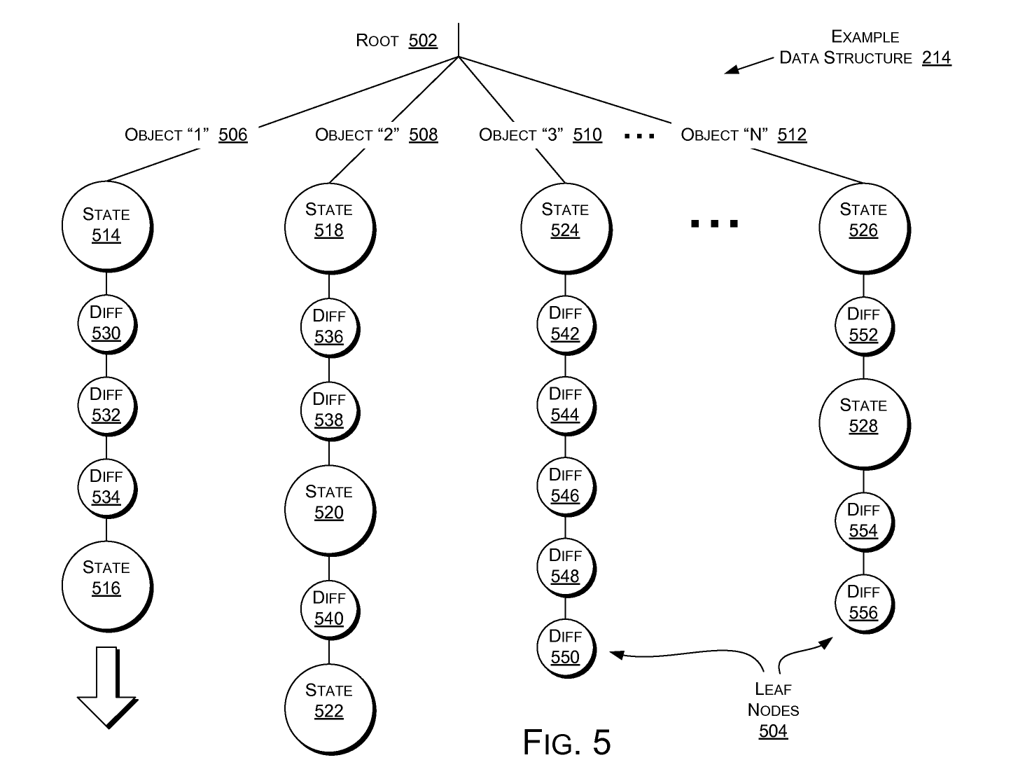

FIG. 5 shows another example data structure 214, for storing undo/redo instructions. The illustrated example data structure 214 comprises a lookup tree or other hierarchical tree of nodes representing undo/redo instructions, with a root 502 that provides the initial entry point for each query, intermediate nodes each representing an undo/redo instruction for an operation of the software program 102, and one or more distal ends where leaf nodes 504 represent an undo instruction for each most recent operation performed on respective objects. In one implementation each node represents an undo operation, a reverse of the original operation, not a record of the original operation per se. Thus, in one implementation the example data structure 214 is a backwards-directed undo tree. Other schemes may be used to create example data structures 214. The validator 206 may filter whether a given node can be added to the tree. For example, an undo instruction that is impossible from the outset will not be added.

In FIG. 5, each branch of the hierarchical tree of nodes represents an object, such as an object “1” branch 506, an object “2” branch 508, an object “3” branch 510, . . . , and an object “N” branch 512. The term “object” may refer to an object as classified by the software program 102, or a part of such an object designated by user via the object designator 204 to be treated as a separate object in its own right, or a designated group of objects to be treated as one object. In other words, in some implementations, the user is given control via the object designator 204 over what is considered an object for purposes of executing a sequence of undo/redo actions focused on just that object. A sequence of undo/redo actions for an object, e.g., branch 506, thus proceeds from the relevant undo node along adjacent nodes toward the root 502 of the hierarchical tree of nodes, even though when the operations originally occurred in chronological order, operations on other objects intervened in a chronological order of operations.

In one example, presented to illustrate possibilities for constructing an example data structure 214, the tree includes state-based nodes (e.g., 514, 516, 518, 520, 522, 524, 526, and 528) and differential-based nodes (e.g., 530, 532, 534, 536, 538, 540, 542, 544, 546, 548, 550, 552, 554, and 556). Even though a state-based node 514 and a differential-based node 530 are shown in FIG. 5 as being different sizes, in one implementation the nodes on the hierarchical tree of nodes are not different types of nodes, but merely store different content. A state-based node 514 stores a pointer to a stored copy of the entire object recorded, for example, in the object state storage 210 of FIG. 2. Since the example data structure 214 of FIG. 5 represents a tree of undo/redo instructions, the stored copy of the object captures the state of the object before the operation to which the undo/redo instruction applies. That is, when a state-based node 514 is read for an undo instruction, the undo instruction retrieves the entire object from the object state storage 210. The retrieved object represents the object before the operation was performed, i.e., in an undone state with respect to the operation that was later performed.

A differential-based node 530 contains a difference between the state of an object before an operation and the state of the object after the operation, i.e., the differential-based node 530 stores the change in the object across the operation rather than a pointer to a copy of the object itself. The differential stored by the differential-based node 530 may be metadata that describes the difference in the state of the object, rather than data or a residue that represents a literal subtraction between two states of the object. Thus, in one implementation the differential-based node 530 may store the name of a property and a value for the property that represent the state of the object before the operation is applied. The stored differential is thus an undo instruction that directs the object back to a pre-operation state. So the node's content, for example,

“Property=color; Value=orange”

is not a description of the resulting object after the operation, but instead an instruction to undo by changing the color back to the value stored, i.e., orange.

In an alternative implementation, each state-based node 514 stores the actual object itself in a previous state, rather than a pointer to a stored copy of the object, e.g., recorded in the storage 210. Such an implementation, however, is used only when the objects are relatively small, or when the nodes have a relatively large storage capacity.

Returning to FIG. 2, in one implementation the node type selector 222 chooses a node type or selects a storage scheme that maximizes performance, such as increasing speed and/or decreasing data size, memory consumption, disk consumption, power consumption, etc. In one implementation, the node type selector 222 makes a differential selection of node type based on the data size needed and/or difficulty imposed on describing the change in an object as a result of a given operation. In one example scenario, the node type selector 222 determines whether a given undo/redo instruction will be stored in a differential-based node 530, introduced above, or a state-based node 514. Thus, in one variation of the node type selector 222, a differential size evaluator may apply a size threshold above which a large differential between object states due to an operation will not be stored on a differential-based node 530 but instead a state of the object itself will be stored in a state-based node 514. For example, the threshold may be exceeded when a user associates a large clipboard full of text with an object. The object size evaluator may apply another size threshold below which an object state will be simply be stored directly on a state-based node 514 rather than storing a pointer to a copy of the object state stored remotely from the example data structure 214, such as in object state storage 210.

Thus, each branch of the example hierarchical tree of nodes shown in FIG. 5 stores a sequence of undo/redo instructions for a given object, in a sequence of nodes. Each branch consists of differential-based nodes 530 unless an operation results in a change in the object that is so large that it is easier to try to store the object itself than to store the change in the object. This scheme for storing undo/redo instructions provides versatility for applying the undo/redo support module 104 to diverse software programs 102, because the example data structure 214 is adaptable and well-equipped to handle many different kinds of objects, and their changes, of all different sizes.

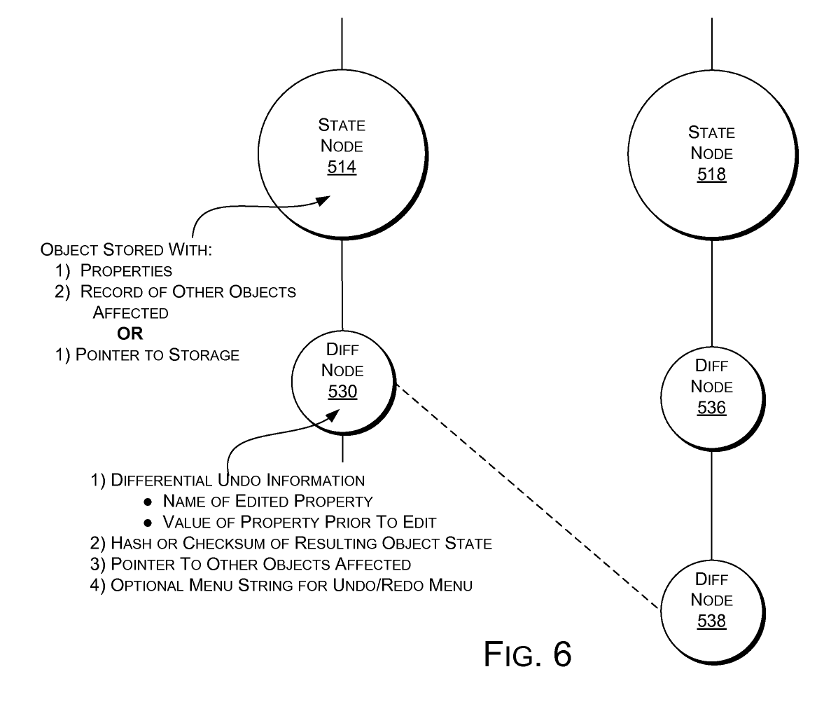

The node generator 218 (FIG. 2) also includes a multi-object tracker 224, a validation data engine 226, and optionally a menu data generator 228. As shown in FIG. 6, other useful information besides an undo/redo instruction can be stored in each node of the example data structure 214 shown in FIG. 5. When a given operation of the software application 102 affects multiple objects, the multi-object tracker 224 can store one or more pointers connecting nodes representing the same operation on different branches of the example hierarchical tree, that is, connecting the same operation across multiple objects. In a typical implementation, this means that the undo-redo executor 216 performs the undo/redo action on all the objects originally affected by the one operation being undone/redone.

In one implementation, depending on the size and nature of the object, the validation data engine 226 may perform a test, such as a hash or a checksum, on an object to generate data for verifying undoability/redoability. For example, the test can be performed on the object as the object exists after the operation for which the undo/redo instruction is being stored. The test information for an object, such as a hash or checksum value, is stored on the same node as the undo/redo instruction for the object. The test information enables the validator 206 to verify the condition of at least part of the application data set before performing the undo/redo instruction. Other verification measures may be stored besides a hash or checksum of an object state. For example, when the object is relatively small, the object itself might be stored on the node as an undoability/redoability verification measure. In a high availability version of the undo/redo support module 104, each node may store a pointer to a complete copy of the object as it exists after each operation, although this can use a lot of data storage space and in the illustrative example just described above, defeats the performance advantages of having state-based nodes 514 and differential-based nodes 530 in the same tree.

In one example implementation, when the node reader 220 of the database controller 212 reads a node in preparation for executing an undo/redo instruction, the validator 206 verifies the undoability/redoability, for example by comparing the stored hash of the object with the current state of the object in the application data set to determine if the current condition of the application data set will allow a valid undo/redo action.

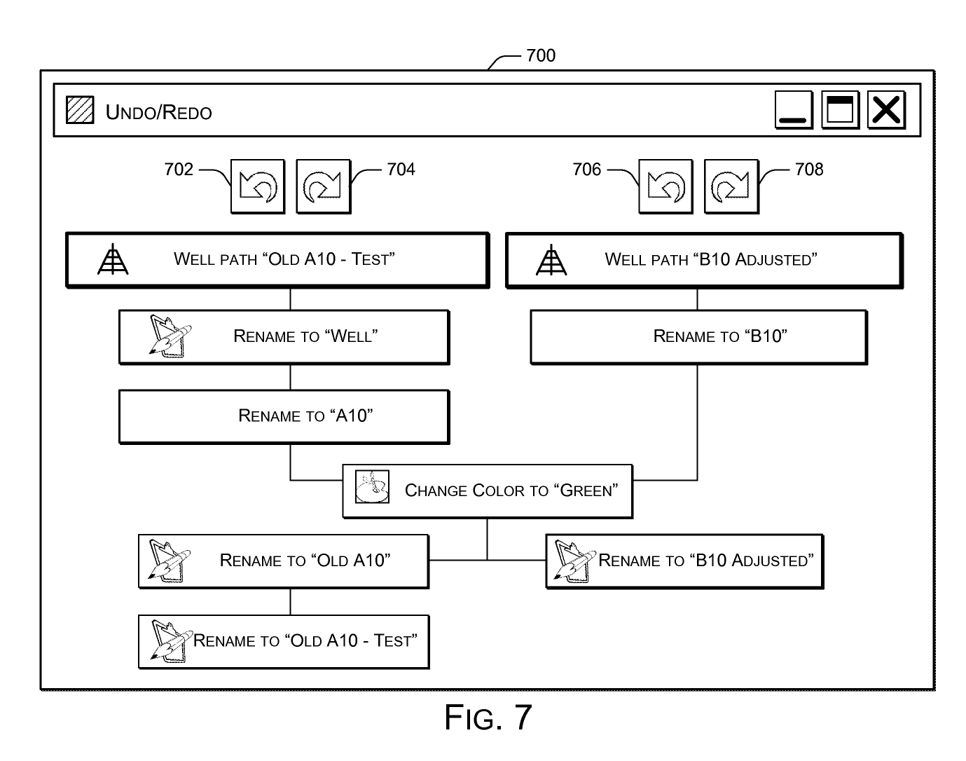

In one implementation, the menu data generator 228 derives undo/redo menu information (e.g., name, icon to display, action enabled, action disabled, etc.) from the state of nodes in the data structure 214. For example, the menu data generator 228 may apply example code, such as:
menu.Text=“Undo”+undoaction.Type+“of”+undoaction.AffectedObject.Name (“Undo rename of Well B8”
menu.Enabled=undoAction.IsUndoValid
   to generate a menu string and validate the associated undo action, in the process of making an undo/redo menu 700, such as that shown in FIG. 7. The menu string generated from each node of the example data structure 214 typically consists of an easily readable paraphrase of the undo/redo instructions. For example, if undo/redo instructions consist of the metadata: “property=name” and “value=‘Lake Placid’” then the menu string might read, “Change name to Lake Placid.”

In another implementation, the menu data generator 228 stores a menu string or other data on each node in order for the node reader 220 and the menu data generator 228 to build the undo/redo menu 700, such as that shown in FIG. 7 from the data stored on the nodes. The undo/redo menu 700 shows each undo/redo option available to the user for each of multiple objects, including undo/redo options that apply to multiple objects simultaneously. The undo/redo menu 700 may offer undo/redo icons, for example, 702 and 706 and redo icons, for example, 704 and 708, for each respective object.

When the user designates an object for undo/redo actions, the object identifier 208 passes the identity of the object to the node reader 220, which in one implementation begins at the leaf node (e.g., 504) on the branch dedicated to that object, and derives menu information or alternatively reads the menu strings on each node back to the root 502 of the tree or back a certain number of nodes. The menu generator of the undo/redo executor 216 displays an undo/redo menu (e.g., FIG. 7) constructed from the menu strings or derived from other information associated with the nodes.

As the validator 206 verifies the undoability/redoability of each undo/redo instruction selected by the user, the undo/redo instruction executor 232 passes the undo/redo instruction back to the software application 102 for execution.

Example Methods

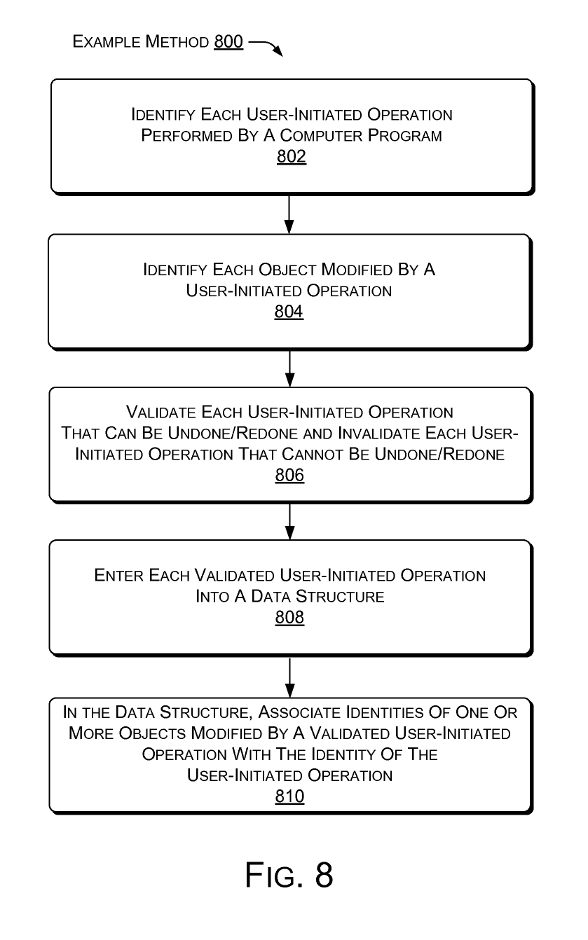

FIG. 8 shows an example method of building a data structure to implement undo/redo support in legacy applications. In the flow diagram, the operations are summarized in individual blocks. The example method 800 may be performed by hardware or combinations of hardware and software, for example, by the example undo/redo support module 104.

At block 802, each user-initiated operation performed by a computer program is identified. Information about each user-initiated operation is sent to an undo/redo support module, which can be separate from the computer program or can be integrated into the computer program. Identifying a user-initiated operation can consist of determining an identifier of the operation itself, or can consist of indicating a change in one or more objects that implies the identity of the operation.

At block 804, each object modified by an operation is identified. If not already accomplished by the previous step, each object affected by the operation is identified, and the information sent to an undo/redo support module.

At block 806, each user-initiated operation that can be undone/redone is validated as undoable/redoable, while each user-initiated operation that cannot be undone/redone is invalidated. That is, in one example implementation, each object affected by a user-initiated operation is checked to determine whether the object can be correctly returned to a previous (or a successive) state. For example, the validating step may merely consist of determining that an instruction or algorithm is accessible for undoing/redoing the operation that acted upon the object. The instruction or algorithm to be applied to undo/redo a given object depends in each case on the operation to be undone/redone and on the nature of the object, as each type of operation may function differently to change its target object in a different manner.

At block 808, each validated user-initiated operation is entered into a data structure. That is, in one implementation, if the particular operation can be validated as undoable/redoable—then the validated user-initiated operation is entered into the data structure that enables undo/redo operations. Otherwise, if the undoability/redoability of an operation cannot be verified, the operation is filtered from becoming part of the undo/redo data structure.

At block 810, in the data structure, the identities of one or more objects modified by a validated user-initiated operation are associated with the identity of the corresponding user-initiated operation. This step enables per-object undo/redo operations, or undo/redo operations that execute across multiple objects modified by a single user-initiated operation.

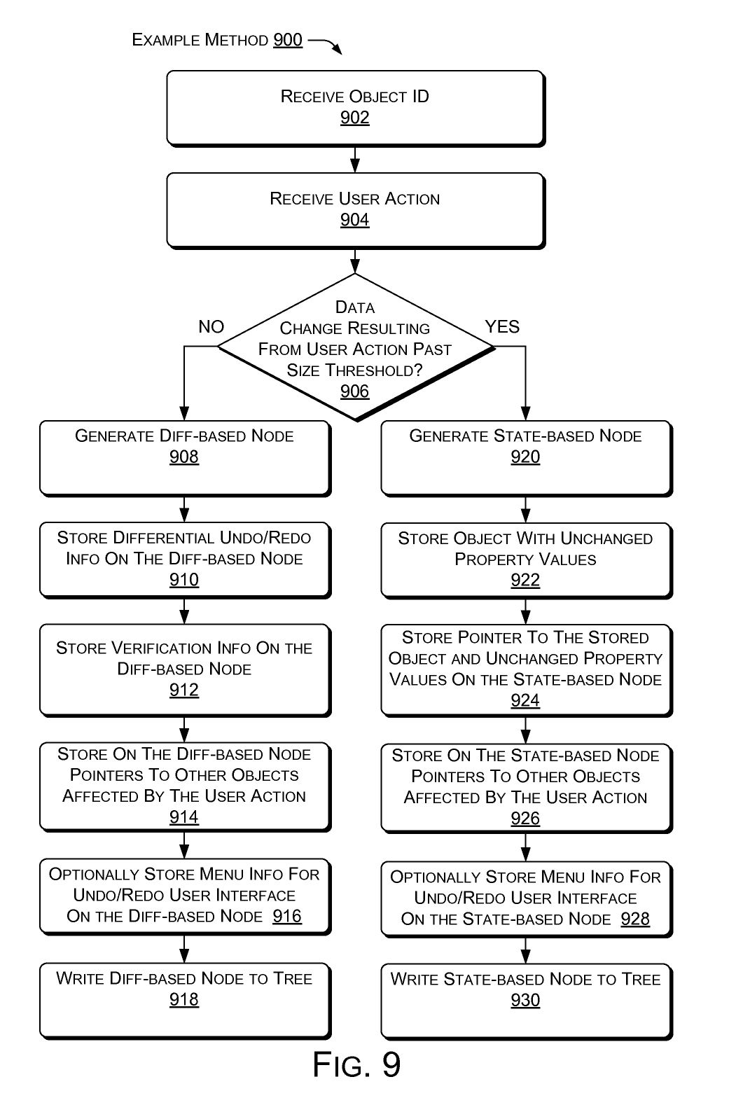

FIG. 9 shows an example method 900 of generating nodes in a data structure to represent undo/redo operations. The method 900 is just one example, other node-generating or data structure-generating techniques may also be used. In the flow diagram, the operations are summarized in individual blocks. The example method 900 may be performed by hardware or combinations of hardware and software, for example, by the example node generator 218.

At block 902, an identity of an object being acted upon by an operation of a software application is received. The identity of the object can be pre-defined in the software application or can be defined on the fly by a user during runtime of the software application.

At block 904, a user action is received. The user action is a user-initiated operation performed on an object associated with the pre-existing software application. The act of receiving may result from the software application sending the identity of the operation or the software application sending a before-and-after state of the object, implying the operation.

At block 906, a data size difference in the object before and after the operation is determined and compared to a threshold. When the data size difference is larger than a threshold, then the method generates a state-based node, otherwise the method generates a differential-based node.

At block 908, the method commences generating the differential-based node.

At block 910, a differential change in the object state is stored as an undo/redo instruction(s) on the differential-based node.

At block 912, verification information, for example a hash or checksum of an object state resulting from the operation, is stored on the differential-based node.

At block 914, when the operation was simultaneously performed on multiple objects, one or more pointers to the other objects are stored on the differential-based node.

At block 916, menu information for an undo/redo menu is optionally stored on the differential-based node.

At block 918, the differential-based node is written to a data structure, e.g., consisting of a hierarchical tree of nodes, at a leaf position of a branch of the tree representing the object.

At block 920, when the data size difference of the object before and after the operation exceeds the threshold at block 906, the method commences generating a state-based node instead of a differential-based node.

At block 922, the object or metadata describing the state of the object as the object existed before the operation is stored. The undo/redo instruction for the node consists of restoring the stored object to this previous state.

At block 924, a pointer to the stored object is stored on the state-based node as the undo/redo instruction.

At block 926, when the operation affected multiple objects, one or more pointers to the other objects are stored on the state-based node.

At block 928, menu information for an undo/redo menu is optionally stored on the state-based node.

At block 930, the state-based node is written to a data structure, e.g., consisting of a hierarchical tree of nodes, at a leaf position of a branch of the tree representing the object.

The example method 900 has many variations. For example, the method 900 can comprise placing nodes in the data structure 214 for only those operations that can be verified as undoable/redoable beforehand. In some instances, redo operations can just be a reversal of the undo instructions. Or, the method 900 can comprise storing an undo/redo instruction for each operation of the computer program in a data structure, associating each undo/redo instruction with one or more objects affected by the associated operation, and verifying the undoability/redoability of each undo/redo instruction before performing the undo/redo instruction.

The method can further include receiving data from the computer program characterizing an object, including an object identifier, an object type, object properties, and values for the object properties. In an example response to an operation of the computer program that changes a value of an object property, the method evaluates a difference in a data size of the object before and after the operation. When the difference in the data size is larger than a threshold value, the method generates a state-based node to represent undo/redo instructions for the operation, which includes: storing the object with the value of the object property unchanged, storing a pointer to the stored object on the state-based node, and writing the state-based node to a branch of a storage tree associated with the object in the data structure.

When the difference in the data size is not larger than the threshold value, the method generates a differential-based node to represent undo/redo instructions for the operation, and stores differential undo/redo information on the differential-based node. The differential undo/redo information can include a value of the object property that existed before the operation. The method 900 then writes the differential-based node to a branch of the storage tree associated with the object in the data structure.

In the data characterizing the object, the “object type” typically specifies data contents, operations, and parameter values characteristic of the type of object. Each branch of the storage tree represents a different object and comprises a sequence of the state-based nodes and the differential-based nodes representing a sequence of undo/redo operations selectable by a user.

The method 900 stores pointers to identify other objects affected by the operation, and the pointers are stored on either the state-based node or the differential-based node that represents the undo/redo instruction for the operation. The method 900 can also optionally store menu information on the state-based node or on the differential-based node for generating an undo/redo menu on a user interface. Thus, the method 900 includes reading the data structure, extracting menu information stored on at least some of the nodes in the data structure, and displaying an undo/redo menu on a user interface of the computer program based on the menu information.

Importantly, the method 900 can store undoability/redoability verification information on at least each differential-based node. For example, the method 900 may store a verified pre-approval that an operation can be undone/redone; or may store verification data for future validation of undoability/redoability, such as a hash or checksum of a resulting state of the object after the operation changes the object; or may store other types of verification information. The verification data can be used before performing the undo/redo instructions on the node, for checking the condition of the application data set to make sure the undo/redo operation is possible without corrupting the object.

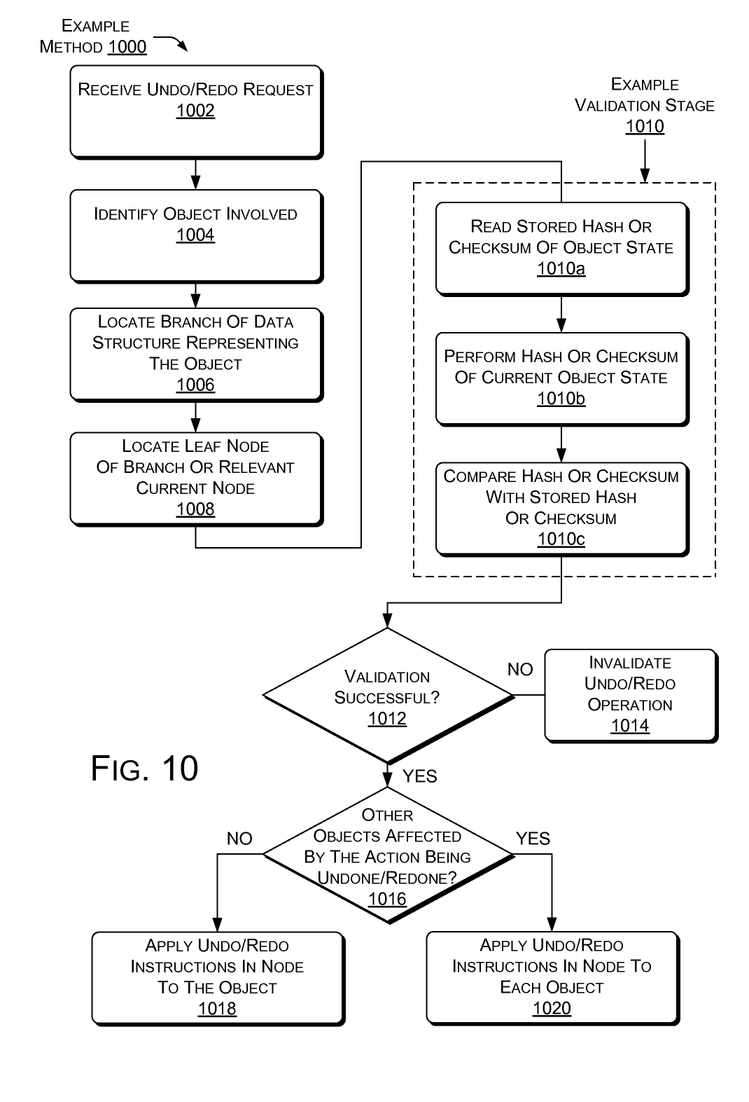

FIG. 10 shows an example method of verifying undoability/redoability of an operation before applying an undo/redo instruction. In the flow diagram, the operations are summarized in individual blocks. The example method 1000 may be performed by hardware or combinations of hardware and software, for example, by the example undo/redo support module 104.

At block 1002, an undo/redo request is received.

At block 1004, an object associated with the undo/redo request is identified.

At block 1006, in a data structure of undo/redo instructions, a branch of the data structure is located that represents the object.

At block 1008, a leaf node of the branch of the data structure or a relevant current node is located representing the relevant operation performed on the object that is to be undone/redone.

The set of blocks 1010 represent an example validation stage. Undoability/redoability is verified before applying the undo/redo operation.

At block 1010a, validation data, such as a hash or checksum of the object's expected state, is read from the node.

At block 1010b, the current state of the object is assessed, such as by performing a current hash or checksum of the current state of the object.

At block 1010c, the validation data are compared, for example the stored hash or checksum can be compared with the current hash or checksum to verify that the part of the application data set corresponding to the object is in condition for the undo/redo action.

At block 1012, a determination is made whether the validation was successful or not.

At block 1014, when the validation of undoability/redoability does not succeed, then the undo/redo action is invalidated and not performed.

At block 1016, when the validation succeeds, the method determines whether multiple objects were affected by the operation about to be undone/redone.

At block 1018, when no other objects were affected by the operation, the undo/redo instruction stored on the node is applied to the object.

At block 1020, when other objects were affected by the operation, the undo/redo instruction stored on the node is applied to the multiple objects.

The method 1000 may further maintain a current record pointer or a current node pointer at the currently accessed record or node in the data structure. The method 1000 may also further include receiving a redo request from the computer program, reversing an undo instruction associated with the redo request, the undo instruction being stored in a node adjacent to the current node pointer.

In a variation, the method 1000 includes receiving an undo request from a legacy computer program, wherein the undo request relates to an operation that is not the most recent operation performed on an object; locating a node of the data structure that includes an undo instruction responsive to the undo request; and reckoning the node a parent node; validating and then performing each undo instruction in each child node of the parent node in a sequence from the leaf end of the branch associated with the object to the newly assigned parent node; and then validating and performing the undo instruction associated with the newly reckoned parent node itself. This automatically executes an undo of all subsequent operations performed on the object after the operation selected to be undone, and then undoes the selected operation itself.

### CONCLUSION

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed systems, methods, and structures.

1. A machine-readable medium, tangibly embodying a set of instructions executable by the machine to perform a per-object undo/redo process in a computer program that has limited or no undo/redo functionality, comprising:
receiving at least an identity of an operation performed by the computer program;
determining an undo/redo instruction for the operation;
testing a validity of the undo/redo instruction in order to generate a validated undo/redo instruction;
associating the validated undo/redo instruction with an identity of each object of the computer program affected by the operation; and
storing the validated undo/redo instruction, the identity of the associated operation, and the identity of each object of the computer program affected by the operation in a data structure.

2. The machine-readable medium as recited in claim 1, wherein testing the validity of the undo/redo instruction includes determining a current state of an object affected by the operation and determining whether applying the undo/redo instruction returns the object to a previous state.

3. The machine-readable medium as recited in claim 2, further comprising instructions to discard an undo/redo instruction and an identity of the associated operation from storage in the data structure when the undo/redo instruction is not valid for returning the object affected by the operation to a previous state of the object.

4. The machine-readable medium as recited in claim 1, further comprising:
receiving an undo/redo request;
validating an undo/redo instruction responsive to the undo/redo request; and
executing the undo/redo instruction.

5. The machine-readable medium as recited in claim 4, further comprising instructions to select a data structure to increase undo/redo performance, including one of increasing computing speed and/or decreasing data size of the data structure, memory consumption, disk consumption, or power consumption.

6. The machine-readable medium as recited in claim 4, further comprising instructions for:
receiving data from the computer program characterizing an object associated with the computer program, including an object identifier of the object, an object type of the object, object properties of the object, and values for the object properties;
in response to an operation of the computer program that changes a value of an object property, evaluating a difference in a data size of the object before and after the operation;
when the difference in the data size is larger than a threshold value, generating a state-based node to represent undo/redo instructions for the operation, comprising:
storing the object with the value of the object property unchanged;
storing a pointer to the stored object on the state-based node;
writing the state-based node to a branch of a storage tree associated with the object in the data structure;
when the difference in the data size is not larger than a threshold value, generating a differential-based node to represent undo/redo instructions for the operation, comprising:
storing differential undo/redo information on the differential-based node, the differential undo/redo information comprising a value of the object property that existed before the operation; and
writing the differential-based node to a branch of the storage tree associated with the object in the data structure.

7. The machine-readable medium of claim 6, wherein in the data characterizing the object, the object type specifies data contents, operations, and parameter values characteristic of the type of object.

8. The machine-readable medium of claim 6, wherein each branch of the storage tree represents a different object and comprises a sequence of the state-based nodes and the differential-based nodes representing a sequence of undo/redo operations selectable by a user.

9. The machine-readable medium of claim 6, further comprising instructions for storing pointers to identify other objects affected by the operation, wherein the pointers are stored on either the state-based node or the differential-based node that represents the undo/redo instruction for the operation.

10. The machine-readable medium of claim 9, further comprising instructions for:
reading the data structure;
deriving menu information from at least some of the nodes in the data structure; and
displaying an undo/redo menu on a user interface of the computer program based on the menu information.

11. The machine-readable medium of claim 6, further comprising instructions for storing, on the differential-based node, validation data derived from a resulting state of the object after the operation changes the value of the object property.

12. The machine-readable medium of claim 11, further comprising instructions for:
storing, on the differential-based node, a hash or checksum of a resulting state of the object after the operation changes the value of the object property;
receiving an undo/redo request from the computer program related to the object;
locating an undo/redo instruction for the one or more objects in the data structure; and
using the hash or checksum to verify the undoability/redoability of the undo/redo instruction before performing the undo/redo instruction.

13. The machine-readable medium of claim 12, further comprising instructions for:
maintaining a current record pointer or a current node pointer at the currently accessed record or node in the data structure;
receiving a redo request from the computer program; and
reversing an undo instruction in response to the redo request, wherein the undo instruction is stored in a node adjacent to the current node pointer.

14. The machine-readable medium of claim 13, further comprising instructions for:
receiving an undo request from the computer program, wherein the undo request relates to an operation performed on an object that is not the most recent operation performed on the object;
locating a node of the data structure that includes an undo instruction responsive to the undo request and reckoning the node a parent node;
performing each undo instruction of each child node of the parent node in a sequence from the leaf end of the branch associated with the object to the parent node; and
performing the undo instruction associated with the parent node.

15. A machine-readable medium, tangibly embodying a set of instructions executable by the machine to perform a per-object undo/redo process in a computer program that has limited or no undo/redo functionality, comprising:
storing an undo/redo instruction for each operation of the computer program in a data structure, each undo/redo instruction classified according to one or more objects affected by the associated operation;
validating an undoability/redoability of each undo/redo instruction before applying the undo/redo instruction.

16. The machine-readable medium of claim 15, wherein validating the undoability/redoability of each undo/redo instruction includes:
determining a current state of data representing an object to be returned to a previous state by the undo/redo instruction; and
determining an ability of the undo/redo instruction to act on the data to return the data to the previous state.

17. The machine-readable medium of claim 16, further comprising instructions for determining a current state of data representing multiple objects to be returned to previous states by the undo/redo instruction; and
determining an ability of the undo/redo instruction to act on the data to return the multiple objects to multiple corresponding previous states.

18. The machine-readable medium of claim 16, further comprising instructions to construct an undo/redo menu based on the stored undo/redo instructions.

19. A system, comprising:
means for storing an undo/redo instruction for each operation of a computer program in a data structure, each undo/redo instruction classified according to one or more objects affected by the associated operation; and
means for validating an undoability/redoability of an operation before applying the undo/redo instruction to the operation.

20. The system as recited in claim 19, further comprising means for validating the undo/redo instruction before storing the undo/redo instruction; and
means for discarding invalid undo/redo instructions from the storage.
